(19) United States
(12) Patent Application Publication
(10) Pub. No.: US 2012/0150655 A1
(43) Pub. Date: Jun. 14, 2012

(54) INTRA-EBOOK LOCATION DETECTION TECHNIQUES

(75) Inventors: Anupam Seth, Urbana, IL (US); Allie K. Watfa, Urbana, IL (US); Dale Nussel, Mahomet, IL (US); Jonathan Kilroy, Champaign, IL (US)

(73) Assignee: Yahoo! Inc., Sunnyvale, CA (US)

(21) Appl. No.: 12/964,524

(22) Filed: Dec. 9, 2010

(51) Int. Cl. G06Q 30/00

(52) U.S. Cl. 705/14.66

(57) ABSTRACT

Techniques are provided in which usage information is obtained, regarding reading-related usage of an ebook by a reader. The usage information can include, for example, reading rate information, page-flip information, zooming information, highlighting information, read-along information, or read out-loud information. Based at least in part on the usage information, a determination or approximation is made regarding a portion of the ebook being read by the reader, such as a chapter, page, paragraph or sentence. Based at least in part on the portion, the reader is targeted with an advertisement to be presented at least in part via the ebook.

### BACKGROUND

Ebook purchasing has grown dramatically in scale in recent years and continues to grow (where ebooks can include electronic books, magazines, newspapers, other forms of electronic reading material, etc.). Yet advertising directed or targeted to ebook readers, and associated monetization techniques, has been less than optimal and has not fully taken advantage of opportunities presented by ebook reading.

There is a need for better techniques for advertising that may be directed to or targeted to ebook readers.

### SUMMARY

Some embodiments of the invention provide techniques that include allowing an ebook reader to select an advertising setting which specifies permissible forms of advertising to be presented to the ebook reader via one or more ebooks. Based at least in part on the selected setting, the ebook reader may be provided with a reduction relating to the cost of the one or more ebooks. The reduction may be greater if the selected option indicates more valuable permissible advertising. Permissible advertising may be presented to the ebook reader via at least one of the one or more ebooks. In some embodiments, the advertising may be targeted based in part on ebook content, which can include content evidenced as being accessed by the ebook reader at a time of advertisement serving.

In some embodiments, techniques are provided in which a first set of information is obtained regarding ebook content evidenced as being accessed by an ebook reader, such as a page or paragraph being read, for example. Based at least in part on the ebook content, a second set of information is obtained, including multiple ebook advertising targeting parameters. Based at least in part on the targeting parameters, at least one advertisement is targeted to the ebook reader, in which the least one advertisement is to be presented to the reader at least in part via the ebook.

In some embodiments, techniques are provided in which usage information is obtained, regarding reading-related usage of an ebook by a reader. The usage information can include, for example, reading rate information, page-flip information, zooming information, highlighting information, read-along information, or read out-loud information. Based at least in part on the usage information, a determination or approximation is made regarding a portion of the ebook being read by the reader, such as a chapter, page, paragraph or sentence. Based at least in part on the portion, the reader is targeted with an advertisement to be presented at least in part via the ebook.

In some embodiments, techniques are provided in which usage information is obtained, regarding reading-related usage of an ebook by a reader. Based at least in part on the usage information, a determination or approximation is made regarding a portion of the ebook being read by the reader. Based at least in part on the portion, the reader is targeted with a graphical display to be presented at least in part via the ebook. The graphical display provides a social interaction-related recommendation or suggestion relating at least in part to the portion.

### BRIEF DESCRIPTION OF THE DRAWINGS

FIG. 1 is a distributed computer system according to one embodiment of the invention;

FIG. 2 is a flow diagram illustrating a method according to one embodiment of the invention;

FIG. 3 is a flow diagram illustrating a hod according to one embodiment of the invention;

FIG. 4 is a flow diagram illustrating a method according to one embodiment of the invention; and

FIG. 5 is a block diagram illustrating one embodiment of the invention;

FIG. 6 is a flow diagram illustrating a method according to one embodiment of the invention;

FIG. 7 is a flow diagram illustrating a method according to one embodiment of the invention; and

FIG. 8 is a block diagram illustrating one embodiment of the invention.

FIG. 9 is a flow diagram illustrating a method according to one embodiment of the invention;

FIG. 10 is a flow diagram illustrating a method according to one embodiment of the invention;

FIG. 11 is a flow diagram illustrating a method according to one embodiment of the invention;

FIG. 12 is a flow diagram illustrating a method according to one embodiment of the invention;

FIG. 13 is a block diagram illustrating one embodiment of the invention;

FIG. 14 is a block diagram illustrating one embodiment of the invention;

FIG. 15 is a block diagram illustrating one embodiment of the invention; and

FIG. 16 is a block diagram illustrating one embodiment of the invention.

While the invention is described with reference to the above drawings, the drawings are intended to be illustrative, and the invention contemplates other embodiments within the spirit of the invention.

### DETAILED DESCRIPTION

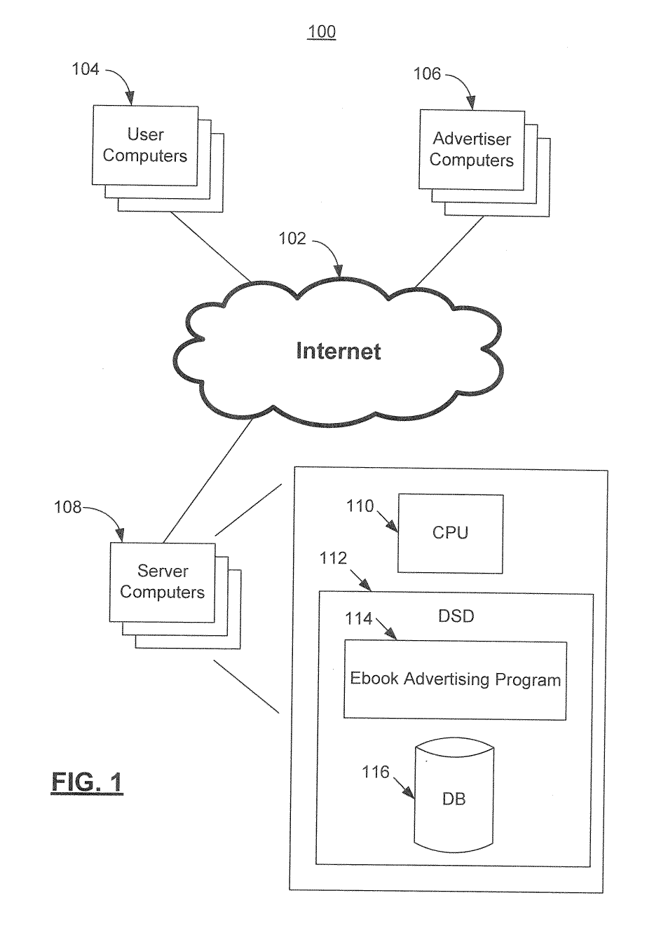

FIG. 1 is a distributed computer system 100 according to one embodiment of the invention. The system 100 includes user computers 104, advertiser computers 106 and server computers 108, all coupled or able to be coupled to the Internet 102. Although the Internet 102 is depicted, the invention contemplates other embodiments in which the Internet is not included, as well as embodiments in which other networks are included in addition to the Internet, including one more wireless networks, WANs, LANs, telephone, cell phone, or other data networks, etc. The invention further contemplates embodiments in which user computers or other computers may be or include wireless, portable, or handheld devices such as cell phones, PDAs, etc.

Each of the one or more computers 104, 106, 108 may be distributed, and can include various hardware, software, applications, algorithms, programs and tools. Depicted computers may also include a hard drive, monitor, keyboard, pointing or selecting device, etc. The computers may operate using an operating system such as Windows by Microsoft, etc. Each computer may include a central processing unit (CPU), data storage device, and various amounts of memory including RAM and ROM. Depicted computers may also include various programming, applications, algorithms and software to enable searching, search results, and advertising, such as graphical or banner advertising as well as keyword searching and advertising in a sponsored search context. Many types of advertisements are contemplated, including textual advertisements, rich advertisements, video advertisements, etc.

As depicted, each of the server computers 108 includes one or more CPUs 110 and a data storage device 112. The data storage device 112 includes a database 116 and an Ebook Advertising Program 114.

The Program 114 is intended to broadly include all programming, applications, algorithms, software and other and tools necessary to implement or facilitate methods and systems according to embodiments of the invention. The elements of the Program 114 may exist on a single server computer or be distributed among multiple computers or devices.

Various monetization techniques or models may be used in connection with advertising, such as sponsored search advertising, including advertising associated with user search queries, and non-sponsored search advertising, including graphical or display advertising. In an auction-based online advertising marketplace, advertisers may bid in connection with placement of advertisements, although many other factors may also be included in determining advertisement selection or ranking. Bids may be associated with amounts the advertisers pay for certain specified occurrences, such as for placed or clicked-on advertisements, for example.

Advertiser payment for online advertising may be divided between parties including one or more publishers or publisher networks, and one or more marketplace facilitators or providers, potentially among other parties. Some models include guaranteed delivery advertising, in which advertisers may pay based on an agreement guaranteeing or providing some measure of assurance that the advertiser will receive a certain agreed upon amount of suitable advertising, and non-guaranteed delivery advertising, which may be individual serving opportunity-based or spot market-based. In various models, advertisers may pay based on any of various metrics associated with advertisement delivery or performance, or associated with measurement or approximation of a particular advertiser goal. For example, models can include, among other things, payment based on cost per impression or number of impressions, cost per click or number of clicks, cost per action for some specified action, cost per conversion or purchase, or cost based on some combination of metrics, which can include online or offline metrics. In some embodiments of the invention, payment may be based on assessed favorable branding or brand engagement value, for example.

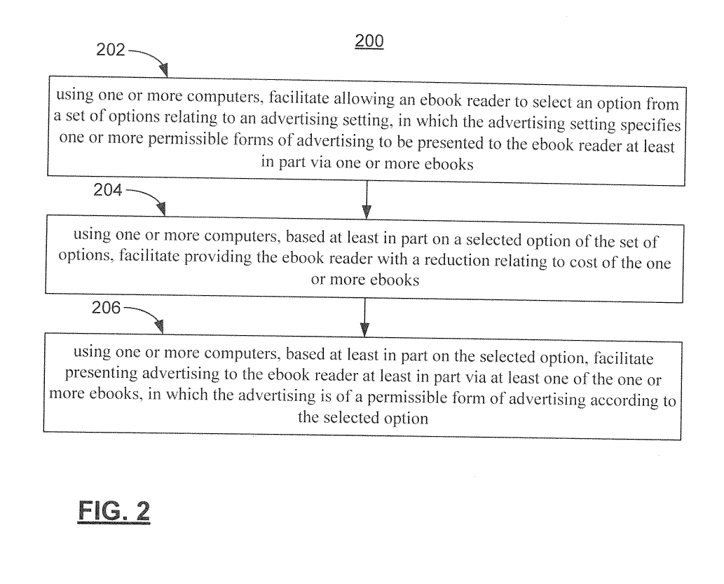

FIG. 2 is a flow diagram illustrating a method 200 according to one embodiment of the invention. At step 202, using one or more computers, the method 200 includes facilitating allowing an ebook reader to select an option from a set of options relating to an advertising setting, in which the advertising setting specifies one or more permissible forms of advertising to be presented to the ebook reader at least in part via one or more ebooks.

At step 204, using one or more computers, based at least in part on a selected option of the set of options, the method 200 includes facilitating providing the ebook reader with a reduction relating to cost of the one or more ebooks.

At step 206, using one or more computers, based at least in part on the selected option, the method 200 includes facilitating presenting advertising to the ebook reader at least in part via at least one of the one or more ebooks, in which the advertising is of a permissible form of advertising according to the selected option.

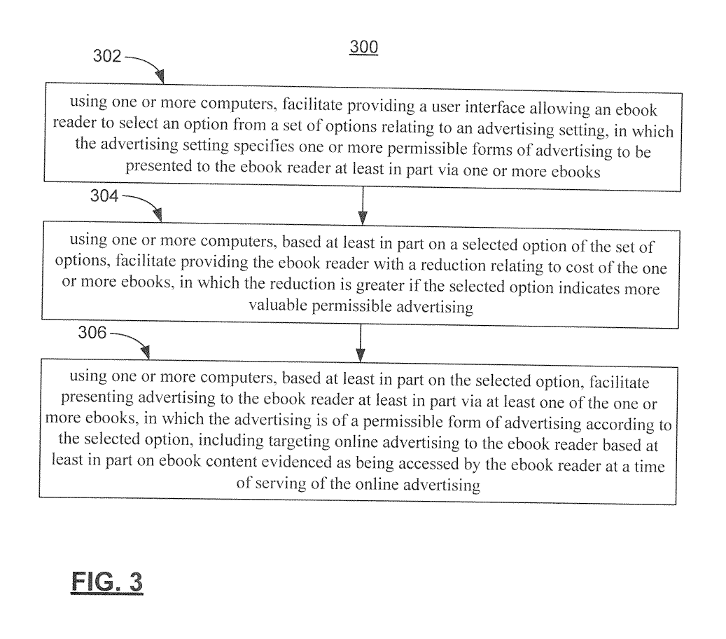

FIG. 3 is a flow diagram illustrating a method 300 according to one embodiment of the invention.

At step 302, using one or more computers, the method 300 includes facilitating providing a user interface allowing an ebook reader to select an option from a set of options relating to an advertising setting, in which the advertising setting specifies one or more permissible forms of advertising to be presented to the ebook reader at least in part via one or more ebooks.

At step 304, using one or more computers, based at least in part on a selected option of the set of options, the method 300 includes facilitating providing the ebook reader with a reduction relating to cost of the one or more ebooks, in which the reduction is greater if the selected option indicates more valuable permissible advertising.

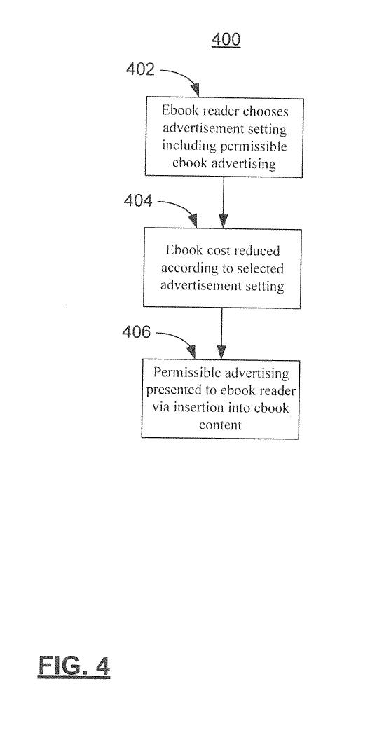

FIG. 4 is a flow diagram illustrating a method 400 according to one embodiment of the invention. At step 402, an ebook reader chooses an advertisement setting including permissible ebook advertising.

At step 404, the ebook cost is reduced according to selected advertisement setting.

At step 406, permissible advertising presented to ebook reader via insertion into ebook content.

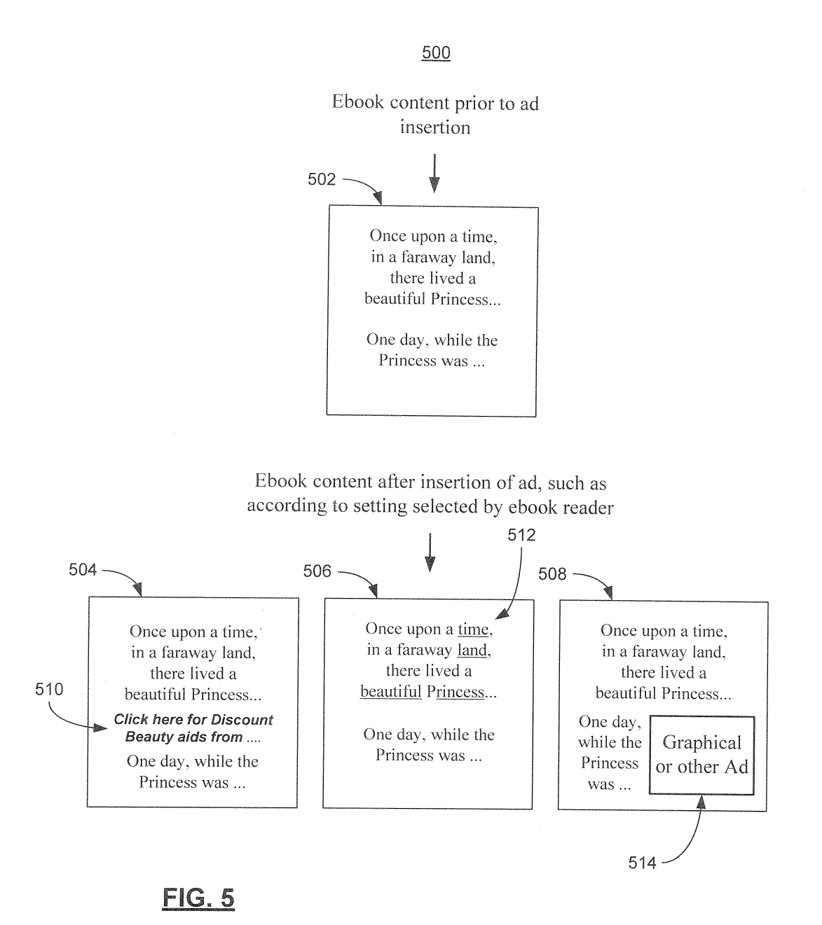

FIG. 5 is a block diagram 500 illustrating one embodiment of the invention. Block 502 is a simplified depiction of ebook content, such as a portion of an ebook page, prior to insertion of any advertisements.

Blocks 504, 506 and 508 are simplified depictions of ebook content after insertion of an advertisement. In some embodiments, the advertisement is of a permissible type as indicated by a setting selected by the ebook reader.

In depiction 504, block 510 is a simplified depiction of an advertisement reading, “Click here for discount beauty aids from . . . ”, inserted within the text of a page in the ebook.

In depiction 506, hyperlinked terms 512 are included in the text of the ebook page, where selecting a hyperlinked term may cause the ebook user to be presented with an associated advertisement, or may take the ebook user, if online, to a Web page associated with the hyperlinked term, for example.

In depiction 508, a graphical or rich media advertisement 514 inserted in an area of an ebook page, and ebook text is shifted as appropriate to make space for it. The advertisement could of any of various types, such as a graphical advertisement, a video or audio advertisement, etc.

As further described below, the depicted advertisements 510, 512, 514 could be targeted, among other ways, according to ebook content, which could include content evidenced as being accessed by an online ebook reader a time of serving of the advertisement, including the accessed term, sentence, paragraph, page, chapter, book, book series, author, etc., as well as specific topical and referenced topics or other items or information of the content, such as referenced people, places, things, emotional or mood associations, the genre or area of the book, etc.

IN some embodiments, advertising can be based on a mood and setting of content being accessed. For example, if the setting includes young characters, a Coke advertisement could be provided, inviting the reader to enjoy a glass of Coke with his or his book, and providing a graphic of a cool glass of Coke, etc.

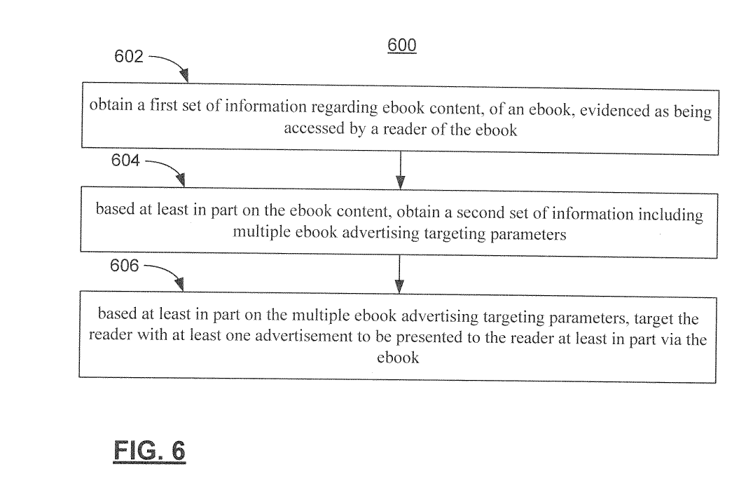

FIG. 6 is a flow diagram illustrating a method 600 according to one embodiment of the invention. At step 602, a first set of information is obtained, regarding ebook content, of an ebook, evidenced as being accessed by a reader of the ebook.

At step 604, based at least in part on the ebook content, a second set of information is obtained, including multiple ebook advertising targeting parameters.

At step 606, based at least in part on the multiple ebook advertising targeting parameters, the reader is targeted with at least one advertisement to be presented to the reader at least in part via the ebook.

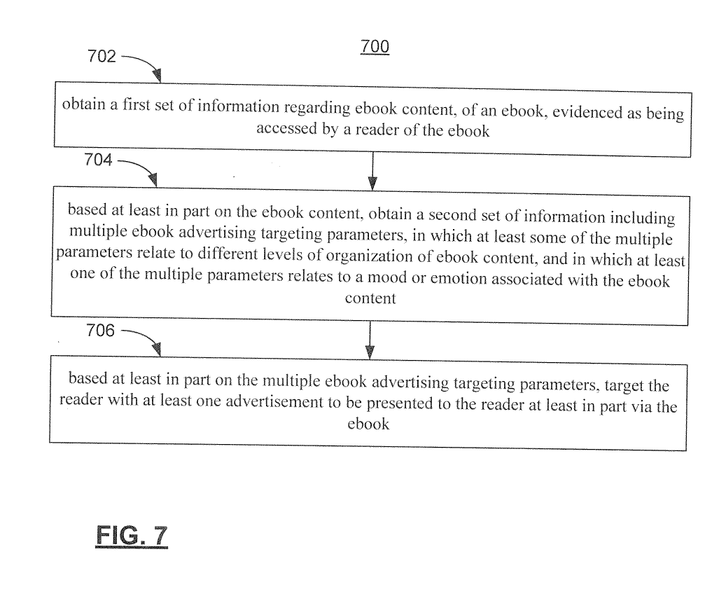

FIG. 7 is a flow diagram illustrating a method 700 according one embodiment of the invention. Step 702 is similar to step 602 as depicted in FIG. 6.

At step 704, based a east in part on the ebook content, a second set of information is obtained, including multiple ebook advertising targeting parameters, in which at least some of the multiple parameters relate to different levels of organization of ebook content, and in which at least one of the multiple parameters relates to a mood or emotion associated with the ebook content.

Step 706 is similar to step 606 as depicted in FIG. 6.

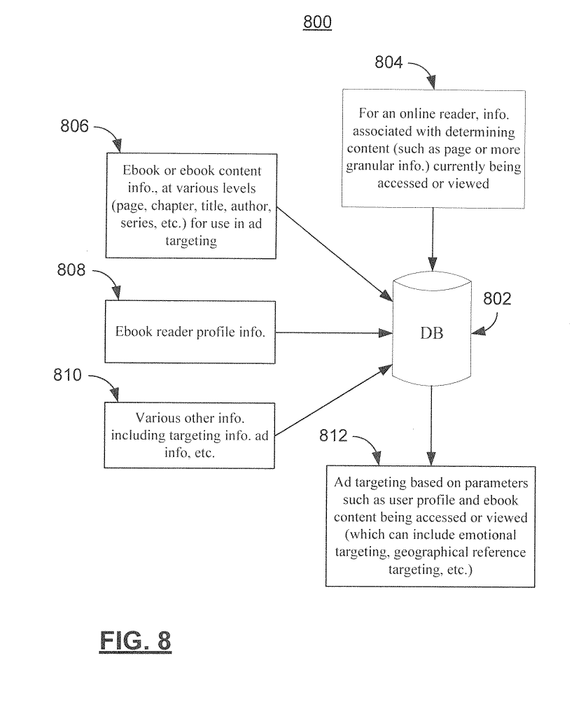

FIG. 8 is a block diagram illustrating one embodiment of the invention. Various types of information are stored in a database 802, including, potentially among other things, ebook and ebook content info., at various levels (word or words, term or terms, paragraph, page, chapter, book title, book series, author, etc.) for use in ad targeting 806, ebook reader profile info, 808, and various other info. including targeting info. ad info, etc. 810, as well as, for an online reader, info. associated with determining content (such as page or more granular info.) currently being accessed or viewed 804.

Block 812 represents ad targeting based on parameters such as an ebook reader profile and ebook content being accessed or viewed (which can include emotional targeting, geographical reference targeting, etc.).

In some embodiments of the invention, ebook users select a type, nature, degree, or level of advertising that will be allowed. In return, they may receive benefit, such as a discount on the cost of the associated ebook or ebooks, for example. The benefit, such as the amount of the cost reduction, may be associated with the level of advertising permitted. For example, greater levels of advertising, which may be more valuable to an advertiser and potentially more distracting to an ebook reader, may warrant higher discounts, etc.

Furthermore, in some embodiments, an ebook reader may be able to make a selection with regard to the type or even quality, desirability or class of permitted advertising. As a simple example, high class advertising may include generally high-impact or highly targeted, relatively desirable advertising. Middle class advertising could include everyday types of advertisements, such as advertisements for everyday products like pizza, etc. Lower class advertising could include advertisements that may be pervasive or generally undesirable, such as teeth whitener advertisements, “lower your mortgage” type advertisements, etc. In some embodiments, the ebook reader's selection in this regard may affect or factor into the provided discount or value, such as by providing a higher or increased discount for selection of lower class advertisements, for example.

In some embodiments, an ebook purchaser and reader may be able, within potentially certain limits, to determine the price that the reader will pay for an ebook, by selecting an advertisement setting that provides a suitable or sufficient discount.

In various embodiments, various parties may be involved in and share in benefit from use of techniques according to the invention, including, for example, the ebook reader, seller, publisher, and advertiser.

In some embodiments, advertisements may be inserted prior to ebook reading, such as being inserted in a static or unchanging fashion prior to downloading of the ebook, for example, such as if the reader is reading offline. In some embodiments, advertisements may be inserted in a dynamic fashion, such as online and based on real-time targeting, which can include targeting based on ebook reading, including a chapter or page being accessed by the reader, etc. In some embodiments, hybrid advertising techniques may be utilized, employing both static and dynamic advertising.

In some embodiments, a formula may be utilized in determining a price for an ebook. For example, in some embodiments. When a customer buys ane-book, the person can be give him a choice of:

1) Buying the book without any ads at regular price (WeightFactor=0);
2) Buying the book with in-line, hyper-linked ads from keywords in the ex content of the books (WeightFactor=a1);
3) Buying the book with in-laid text ads (WeightFactor=a2);
4) Buying the book with in-laid pages/display ads (WeightFactor=a3).
The customer could configure to see an advertisement at a certain frequency, or every N number of pages, for example, where N is configurable, and where higher frequencies, or lower N's, lead to deeper discounts, or may even be great enough to allow the ebook to be obtained for free.

To continue the example, a formula such as the following could be used for computing the price of the e-book:

Price=Publisher price−(Freq, of advertisements×No. of pages purchased*WeightFactor)*(% giveBack*Revenue per advertisement). Publisher price may be the competitive market price for which the publisher would like to offer the book normally, for example. Freq. of advertisements may be the user-configured frequency of seeing an advertisement, for example. Higher no. of pages purchased may lead to higher advertising volume and a greater discount. The weighting factor may be associated with the type of allowed advertising and its effectiveness or performance, or forecasted effectiveness or performance. The % giveBack may be the advertisement revenue percent shared with the end-consumer, for example. Revenue per advertisement may be the average revenue earned by advertisement generation for the specific class or category of allowed advertising or advertisements.

In some embodiments, advertisers may also choose to give incentives like refunding the cost of the e-book in the event of a direct y-consequential click or purchase, online or offline, from or determined to be associated with or caused by a displayed advertisement. This could be an easy low-cost incentive for high-priced items such as laptops, etc.

Various forms of advertisement targeting could be employed. For example, in some embodiments, techniques could be use in with an advertisement is selected based at least in part using targeting attributes of various priorities. As just one simple example, a flow process could be utilized, including a flow through priorities 7, 2 and 3 listed below. Priority 1 will comprise of type of ebook and interest, priority 2 will be user profile setting, priority 3 will be security and filtration.

Priority 1 could include:

A—Type of ebook and method of pricing
B—Interest indicated as part of user's profile
C—Interest indicated at time of ebook purchase

Priority 2 could include:

C—IP location of user at time of purchase
D—Interest indicated as part of users profile

### E—User Gender

Priority 3 could include:

F—appropriateness of advertisement
G—Age of user
H—local user filtration

To continue the example, the system could go through the sequential and continuous flow of A, B, C, D, E, F, G and A having the most impact and then the priority declining as we go down the queue. Of course, many other examples and targeting techniques are possible.

As mentioned above, embodiments of the invention contemplate static advertising as well as dynamic or online advertising, or hybrid techniques making use of both.

In some embodiments, advertising, such as online advertising, is targeted based at least in part on ebook content evidenced as being accessed by an ebook reader. Being targeted based on ebook content can include, for example, being targeted based on parameters relating to various levels of organization of the book associated with accessed content, including, for example, a word, words, term, sentence, paragraph, chapter, or even book or book or book title (even though obviously an entire chapter may not be being accessed, but rather content thin the chapter, for example). Targeting can also be based on higher level or less directly associated parameters, such as book author, book series, etc.

Any of various techniques or combinations of techniques can be used in embodiments of the invention in determining (whether for certain or with any of various levels of confidence or certainty), estimating or guessing what content is being accessed or is likely to be being accessed. In some embodiments forecasting and predicting based on various information may be utilized, including factors relating to the ebook as well as potentially the reader or the reading, such as the reader's rate of reading, scrolling information etc. Utilized information could include zooming-in or other viewing tools used by the reader. Furthermore, in some embodiments, machine learning or other sophisticated techniques could be employed in making determinations or predictions. In some embodiments, it may be straightforward to determine a page of the ebook being accessed by an online reader at a given time, for instance. In some embodiments, it may be possible to determine or guess, with varying degrees of confidence, at more granular levels, such as down to a sentence or even term or word being accessed or read.

Some embodiments of the invention include targeting that takes advantage of accessed content targeting at several different levels of organization with regard to the ebook. For example, targeting could be based on a topic or mood associated with the title of the book as well as a topic or mood associated with content at a more granular level, such as the particular chapter, or even paragraph or sentence, for example. In some embodiments, a combination of such parameters is utilized, which may be more effective than targeting based on each individually. As just one illustrative example, if a book title relates to wineries, and a particular chapter relates to a particular area of California, then advertising could relate to a winery in that area of California, etc.

In some embodiments, advertising may be presented that relates to content being accessed and may tempt the reader or draw the reader's attention with associated useful information or suggestions, along with or otherwise in association with advertising a product or service, for example. For example, at the bottom of a page, an advertisement could be presented that offers or provides a summary of that page or chapter, or an upcoming page or chapter, or that indicates most popular quotes from the book and indicates “brought to you by Company A”, etc. An advertisement could also, for example, suggest or recommend to an ebook reader a previous or the next book in the series, etc. Furthermore, advertisements could use various techniques to encourage further reader engagement, such as by providing the reader with tools, such as a tool to share a paragraph of quote from the ebook, or to visit a site or blog associated with accessed content and also associated with or including advertising associated with the advertiser, etc.

Some embodiments take advantage of or include use of social networking information, such as such explicit or implicit social networking information associated with the ebook reader. For example, some targeting parameters could relate to others a social network of the reader, or associated interests, trending, etc. Furthermore, implicit social networks could be identified for this purpose, such as by determining users that also purchased or read the ebook that the reader is reading, or users that read similar books or books by the same author, or publisher, for example. In some embodiments, advertisers can provide criteria relating to such.

In some embodiments, social networking information could be included in the advertisement itself, such as by indicating to the ebook reader that other readers of that book liked a product, or liked certain other books, for example. Furthermore, in some embodiments, advertisements could recommend related or targeted media or entertainment of various types, such as movies, music, etc.

In some embodiments, tagging by users relating to ebooks and ebook content can be used in targeting. For example, while reading, ebook users may tag ebook content or particular advertising, such as by indicating a simple like or dislike, or by providing more granular opinions. Such tagging could then be used as a parameter in targeting an ebook user with advertising. For example, tagging by users in an explicit or implicit social network of a particular ebook reader could be utilized, emphasized, etc.

In some embodiments, targeting parameters can include not only targeting such as geotargeting, based on a geographic location of the user or other users, but could also be more broadly or additionally based on geographic or location references or setting in the ebook, for example.

In some embodiments, emotional or mood-based targeting is utilized, such as by taking into account an emotional state or situation associated with content being accessed, etc.

In some embodiments, targeting may take into account specific item or situational references in content being accessed, which could include sensory or sense-associated references. For example if content being accessed includes a character enjoying a relaxing cup of hot tea, advertisements could be provided relating to that item, or relaxing drinks or other comfort food products, etc.

In some embodiments, targeting parameters may be based at least in part on user profiles, which can include any of various aspects, including emotional or other profile aspects. Profiles can build using various information including information regarding user choices, tagging, preferences, choices, etc.

In some embodiments, advertising can take advantage of aspects of accessed content that may elude human senses and sensations that the author is attempting to convey. An example of this might relate to, from the book, “Polar Express”, the passage, “ . . . as the kids got seated, the waiter started to serve refreshing hot cocoa as thick and rich as melted chocolate bars . . . . ” This may be an excellent opportunity to show an advertisement for hot cocoa or a Hersey's chocolate bar, as the reader has already been acclimated or positively predisposed by the story he or she is immersed in.

In some embodiments, keywords (which can be words or terms of ebook content, or associated with the ebook or portions thereof, etc.) and tags are utilized, and categories of such, and detected patterns and can trigger advertising associated with the keywords and tags, etc. For example, if keywords or tags relate to love or affection, advertisements can be provided that relate to flowers, food or entertainment, for example.

Furthermore, in some embodiments, a progression over multiple chapters or subjects show that there is a certain mood and tone that falls under a particular category, such as vacations, for example, then the system may detect this pattern and match advertising to the context, such as advertising relating to a vacation offer. As such, some embodiments include using moods and emotions associated with the book in addition to a detected context to trigger advertising that is relevant to both. Furthermore, historical information regarding activities of the ebook reader, such as previous ebooks read by the reader, can be used to further guide and enrich targeting. For example, if the historical information indicates an inclination toward or preference for a particular mood, situation, or topic, or even specific likes such as movies, for instance, then this can be used in targeting or filtering of advertising.

As mentioned above, tagging can be used in some embodiments of the invention. Three types of uses of tagging follow, which may be used in embodiments of the invention.

In some embodiments, if, through a single chapter or subject, keywords and tags suggest showing an advertisement relating to a particular keyword, then the system may detect this and one or more advertisements may be triggered that tail nto this keyword. For example, if advertisements showing love and affection are suggested it this way, then advertisements relating to flowers, food or entertainment may be shown.

Another example of a use of tagging involves collective instances of keywords and tags. For example, if through multiple chapters or subjects that follow each other, it is suggested that there is a certain mood and tone that falls under one category, such as vacations, then the system will detect this pattern and match it to a context. Using the ebook's mood and emotions plus the detected context may trigger advertisements that provide relevant subject matter, such as advertisements that show a destination for a vacation.

Still another example of a use of tagging could involve collective instances of keywords and tags in addition to historical information that may reflect reader interests or likes. For example, if through multiple chapters or subjects plus the history of another book that the user is reading or has read, it is suggested that a certain interest, inclination, mood, or situation is prevalent, then the system may attempt to filter and detect the subject that is associated with this trigger, and then associate it with the history of what the reader likes. This could include showing advertisements elating to movies or other forms of entertainment that may reflect the likes of the reader.

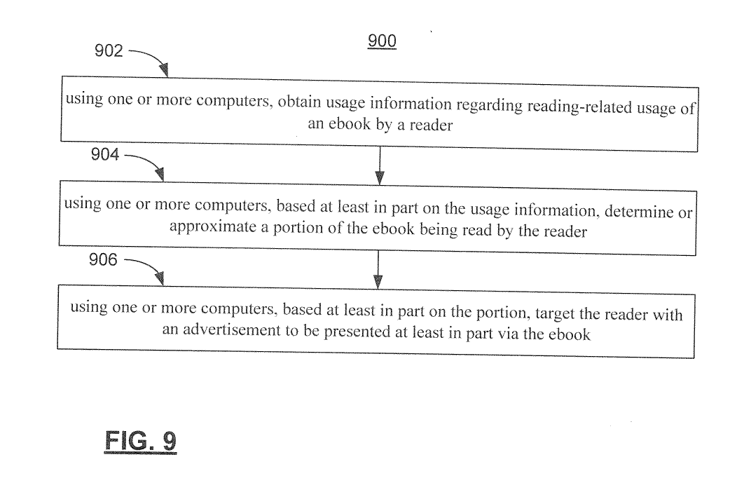

FIG. 9 is a flow diagram illustrating a method 900 according to one embodiment of the invention. At step 902, using one or more computers, usage information is obtained regarding reading-related usage of an ebook by a reader.

At step 904, using one or more computers, based at least in part on the usage information, a portion of the ebook being read by the reader is determined or approximated.

At step 906, using one or more computers, based at least in part on the portion, the reader is targeted with an advertisement to be presented at least in part via the ebook.

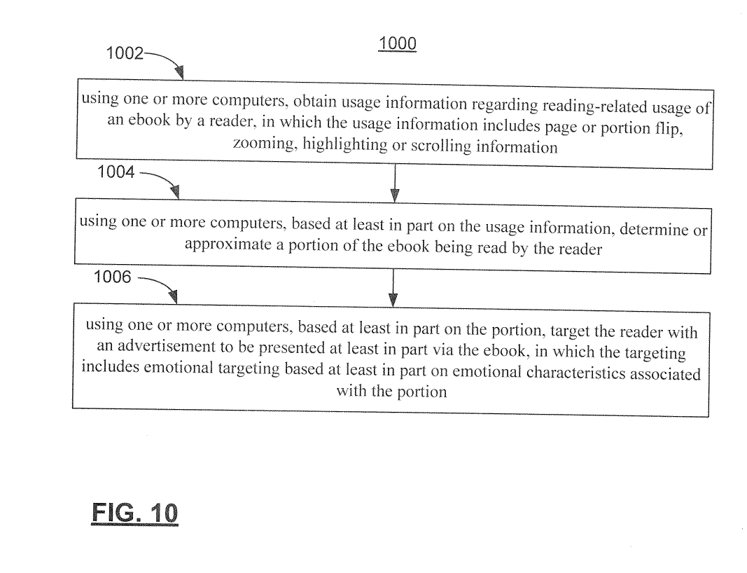

FIG. 10 is a flow diagram illustrating a method 1000 according to one embodiment of the invention. At step 1002, using one or more computers, usage information is obtained regarding reading-related usage of an ebook by a reader, in which the usage information includes page or portion flip, zooming, highlighting or scrolling information.

At step 1004, using one or more computers, based at least in part on the usage information, a portion of the ebook being read by the reader is determined or approximated.

At step 1006, using one or more computers, based at least in part on the portion, the reader is targeted with an advertisement to be presented at least in part via the ebook, in which the targeting includes emotional targeting based at least in part on emotional characteristics associated with the portion.

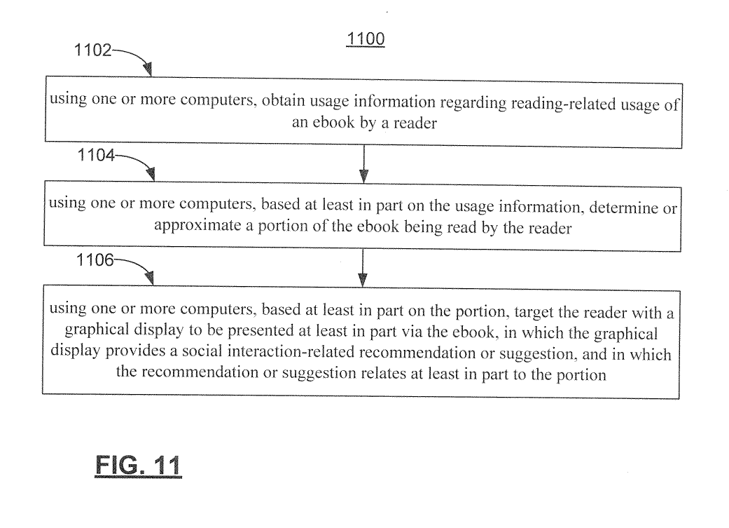

FIG. 11 is a flow diagram illustrating a method 1100 according to one embodiment of the invention. At step 1102, using one or more computers, usage information is obtained regarding reading-related usage of an ebook by a reader.

At step 1104, using one or more computers, based at least in part on the usage information, a portion of the ebook being read by the reader is determined or approximated.

At step 1106, using one or more computers, based a east in part on the portion, the reader is targeted with a graphical display to be presented at least in part via the ebook, in which the graphical display provides a social interaction-related recommendation or suggestion, and in which the recommendation or suggestion relates at least in part to the portion.

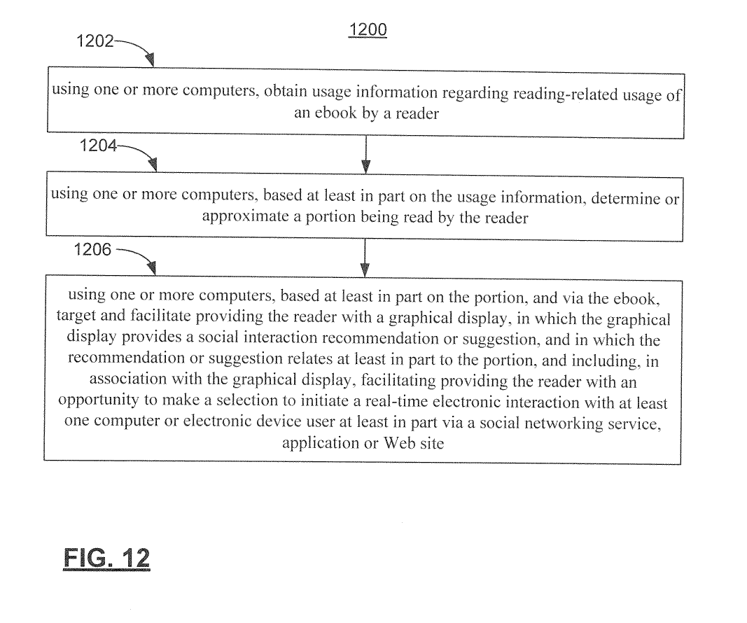

FIG. 12 is a flow diagram illustrating a method 1200 according to one embodiment of the invention. At step 1202, using one or more computers, usage information is obtained regarding reading-related usage of an ebook by a reader.

At step 1204, using one or more computers, based at least in part on the usage information, a portion being read by the reader is determined or approximated.

At step 1206, using one or more computers, based at least in part on the portion, and via the ebook, the method 1200 includes targeting and facilitating providing the reader with a graphical display. The graphical display provides a social interaction recommendation or suggestion. The recommendation or suggestion relates at least in part to the portion. The method 1200 includes, in association with the graphical display, facilitating providing the reader with an opportunity to make a selection to initiate a real-time electronic interaction with at least one computer or electronic device user at least in part via a social networking service, application or Web site.

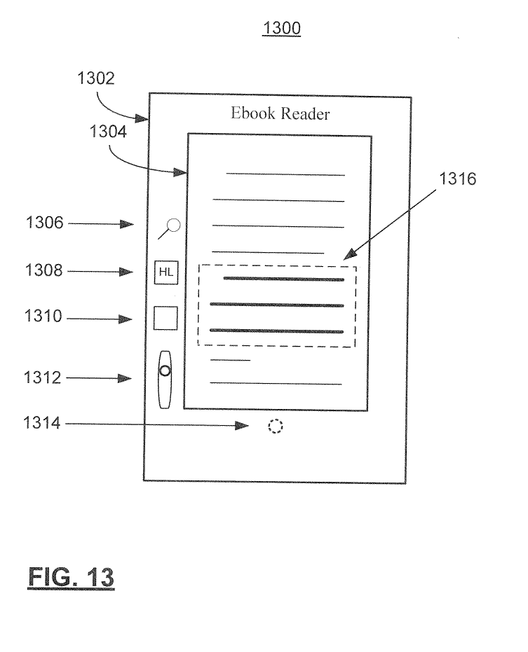

FIG. 13 is a block diagram 1300 illustrating one embodiment of the invention. An ebook reader device 1302 id depicted, including a display 1304 which can show, among other things, reading material of the ebook.

As described herein, according to various embodiments of the invention, many different techniques and sources of information may be used to detect (including determine or approximate) a portion of an ebook being read, or having just been read, by a reader. In various embodiments, such information may be collected locally, such as by the ebook reader device itself or an associated device, or remotely. Additionally, advertisements and messages can be stored, triggered and served or provided locally or remotely, and online or offline. Furthermore, in some embodiments, if a reader moves from online to offline reading or vice versa, or from one device to another, information may be collected and integrated in various ways and combinations, including being collected locally at times, and uploaded at other times, etc.

The ebook reader 1302 may include various functionality that may be used in detecting the portion being read. For example, as depicted the ebook includes a magnify button or feature 1306, a highlight button or feature, a scroll button or feature 1312, and any of one or various other buttons or features 1310. Such features may be used in detection of the portion of the ebook being read, such as including detecting a portion currently or recently page-turned to, shown on the display (and where shown), scrolled, highlighted, magnified, etc. Once the detection is made, this information can be used in many ways, such as in advertisement or content targeting, social networking-related communications, etc., as described herein.

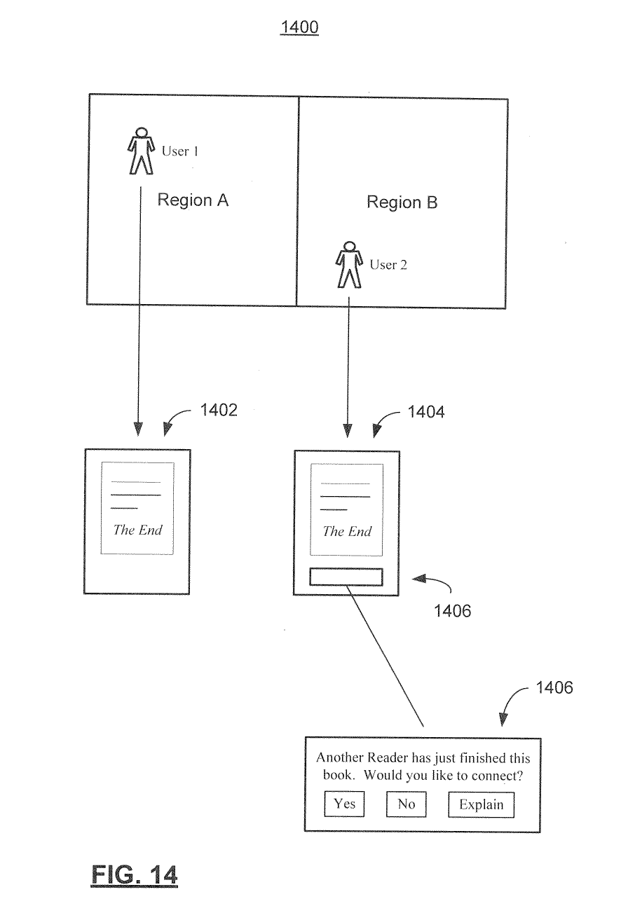

FIG. 14 is a block diagram 1400 illustrating one embodiment of the invention. Two ebook readers, reader 1 and reader 2, are depicted, in two different regions, Region A and Region B. The regions can be large such as countries or states, or smaller regions, even down to street blocks, etc.

As depicted, although they may be initially unaware of it, readers 1 and 2 happen to be reading the same ebook on different ebook reader devices 1402, 1404, and complete it at roughly the same time. Using techniques according to the invention, this can be detected. Of course, they may alternatively have just completed a chapter, paragraph, series of books, different books by the same author, etc.

Once it is detected that the readers have both completed the same book within a short period of time of each other, a message or functionality can be provided to one or both readers that utilizes this information. For example, as depicted, a graphic 1406 may be displayed on the ebook reader device 1404 of reader 2, indicating that another reader (or another reader in the same area, or of similar demographic traits, etc.) has also just finished the same ebook. The graphic 1406 may further invite and provide an opportunity for reader 2 to connect with the other reader, reader 1, such as by instant messaging, video messaging, etc. Alternatively, reader 2 could be invited to connect with many readers who have recently finished the book via a chat room, etc. The connection could also make use of a social networking Web site, service, etc.

The graphic 1406 includes options for reader 2 to select “yes”, “no” or “explain”, where choosing “yes” may initiate the connection, and choosing “explain” may cause an explanation of the connection feature to be displayed, for example.

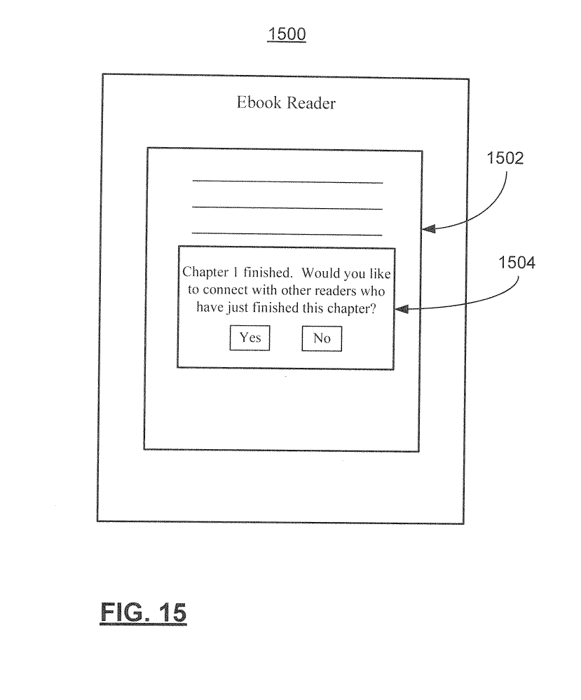

FIG. 15 is a block diagram 1500 illustrating one embodiment of the invention. An ebook reader device is depicted, including a display 1502. As depicted, it is detected that the reader has just finished a chapter, and a graphic 1504 is displayed on the display 1502. The graphic invites the reader to connect, such as via interaction with the graphic, with one or more other readers ho have just finished or have recently finished the same chapter in the same book. For example, if the reader chooses “yes”, the reader may be connected, such as through messaging or a social networking service, with the one or more other readers.

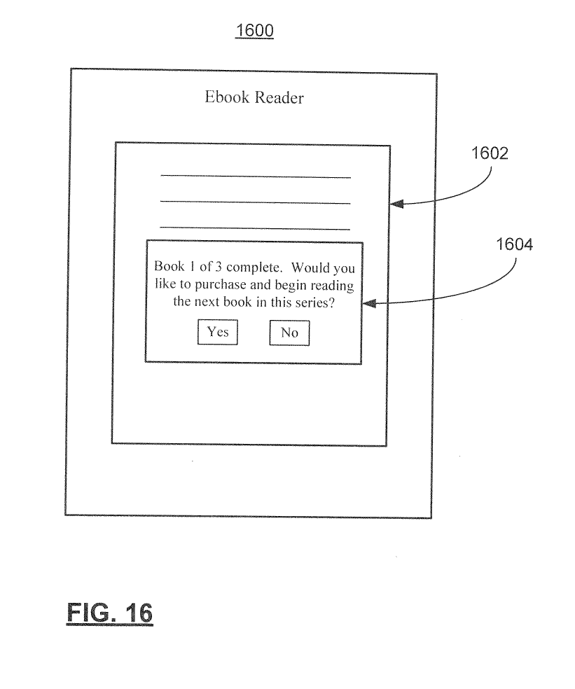

FIG. 16 is a block diagram 1600 illustrating one embodiment of the invention. An ebook reader device and display 1602 are depicted. Following detection that the reader has just finished the ebook, a graphic 1604 is provided on the display 1602, inviting the reader, via interaction with the graphic, to choose to immediately purchase and begin reading the next book in the series, where the reader has just read the first book in the series. Alternatively, the system may allow the reader to choose to review information about the next book before deciding on the purchase.

In some embodiments, methods described herein be utilized for reader applications including mobile, tablets, eBook readers and PC's. In some embodiments, advertisements target the different levels of specific content being read or just read, like a paragraph in an ebook, lich can affect the mind-set of reader. As one reads an ebook, for example, he or she will be reading a word in a sentence, in a paragraph, in a chapter, in a book of a certain genre. So, as the user moves through the reader media, and my us zoom, font enlarge, scroll, select certain pages, etc, the system can use this to help determine the mindset the reader, such as by considering the likely emotional impact of the sentence the user is reading. This, in turn, can be used in advertisement (or other content) targeting, for example. Furthermore, the reading velocity can be used to determine or help determine reading position in the ebook, such as sentence position, of the user, possibly reference to a previous point in time at which the reader the reader was at a certain location in the book or started reading the book. For users who may not use the zoom or font enlarge capabilities, the average rate of reading of a page can be used in estimating the location at which the user is reading. Still further, many reader devices offer the ability to have an audio read-aloud from the ebook. This can also be used to pin-point the position of user. Finally, if the user reads-aloud, this be monitored to detect a spoken portion, and map the location of the user.

Some embodiments make use of the fact that small screen devices, which can include mobile and tablet eBook readers, can offer a potential for better gauging and better targeting of advertisements to users, relative to larger screen devices. Small screen size can also be useful for techniques, such as estimating time spent viewing advertisements, for instance, which can lead to better advertisement performance.

Some embodiments utilize emotional targeting, including detecting or deducing an emotional state of a reader, and using this in advertisement targeting. In particular, according to some embodiments, emotional states and influences associated with portions and levels of an ebook are used in this regard. For example, the location of the reader in an ebook, including the sentence, paragraph, chapter, and book itself, can all provide clues to enhance emotional targeting. For example, if a particular portion of an ebook being read is likely to spike an emotion of the reader, targeting may be employed utilizing this.

Some embodiments include methods and algorithms based on scrolling rates, font sizes, and user activity on electronic small-screen devices, while reading ebooks, including articles, etc. Techniques can include, among other things:

1—Estimating user's position within the media.
2—Reading speed calculation.
3—Read along.
4—Read aloud.

In some embodiments, a particular reader's style or styles may also be determined and utilized. For example, some mannerisms can include:

A—User completes the book and doesn't seem to ever put it down.
B—User completes the book at an expected pace.
C—User is re-reading sections of the book.
D—User is progressing slowly through the book.
E—User never completes the book.

Parameters can be measured, such as start time, duration, end time, and can be used in an algorithm to determine, among other things, the reader's “interest” in the book. This can then be used, for example, in cases A and B to offer other books that have similar genre, themes, subjects, topics. Cases D, E are negative, so it can be recorded that the user wasn't all that interested or didn't like this type book, and this can lead to making suggestions for books deemed not of this type, for example.

Techniques can also be applied with regard to more direct specific human sensations that the author may be attempting to convey. An example of this might be: from the Polar Express book, if it is detected that the reader just zoomed in on the paragraph that starts with, “As the kids got seated, the waiters started to Serve refreshments, including hot cocoa as thick and rich as melted chocolate bars . . . . ” This is an excellent opportunity to target the reader, such as by showing an advertisement for hot cocoa or a chocolate bar, for instance.

Various Factors or actions can be used in determining the location of reader, including the following.

A) Zoom: Including to simulate movement rapidly away from or toward a subject using a zoom functionality. Zooming can allow pin-pointing the paragraph for which the advertisement should be targeted, for example.
B) Font Size: Including to define the size of the font relative to the parent element. Enlarging the font can indicate a focus on one paragraph and can be used in pin-pointing the paragraph for which the advertisement will be targeted.
C) Scroll: Including using the mouse to transition from one part of the document to another such as in a sequential, smooth transition. With this, it may be possible to detect the part of the page that is visible to the user and hence target the advertisements regard to the visible part.

Some embodiments make use of the reading rate of a user. Historical information can be used to determine the average rate for a user of reading of a page, and this can be used in estimating which section the user will be reading at a particular time. In some embodiments, in calculating this, the following factors or parameters may be determined and taken into account.

A—Average time to reading page, and average time to read one line.
B—The margin of error to use.
C—Determining if the user is reading or has put the reading on hold,
D—Taking into account step out and step in, such as if the user stops reading at one page, and later steps back in to continue reading at the same page at a later time.

For example, if the user is determined to be reading, the following steps can be used: calculate the number of lines per page; pull average time to read one line; pull previous time spent on page if applicable; add or subtract the margin of error.

Some readers, such as those too young to read, the visually disabled, etc., may use a read-along feature of a book to have the book read out-loud to them, such as through an audio speaker or headphones. This can be used in book location detection, and in targeting advertisements, such as visual or audio advertisements.

Some readers read out-loud themselves from a book. A microphone on the reader device can capture a phrase of the user, which can be used to map the phrase to a sentence in the page and then detect the portion that the user is currently reading. This can then be used in advertisement targeting.

Some embodiments of the invention incorporate social aspects in connection with ebooks. Some embodiments bring these two together, recognizing that ebook readers, by their very reading, are providing important information relevant to social aspects, targeting, and networking.

Some embodiments of the invention address the innate need of integrating social features like reviews, comments, chat, sharing, etc. into an eBook reader's experience without the reader's initiation. Utilizing determination of reading factors and location, including the book, chapter, paragraph, and sentence that is being or has been read, the system can initiate, or offer to initiate, a social communication that will allow the user to interact with one or more other users. Such other users may have, for example, just finished the particular chapter, and the user may wish to communicate with them, such as to get comments, feedback and help, such as help or clarification in understanding a certain aspect of the chapter, for example.

As another example, after each chapter read, the system can show the most favored quote of the chapter that was submitted by all readers that read the book, or all readers in a user's social network, or a summary of the chapter. This can be sponsored by an advertiser who has a interest in getting a product or service in front of a reader who has just experienced a section of the ebook, for example.

A Web portal, for example, can be integrated into the experience, and can provide a platform that enables eBook readers to have deep integration with various social platforms, catering to people's natural desire to share things about what they are reading at the right time, comment on sections or chapters, interact with other people reading the same book, etc.

Some embodiments include the system initiating social communication. This can include providing a reader with an option to enable or disable the social communication feature, such as using an ebook widget, for example. If enabled, the system may detect the reader's location in the ebook, and initiate, or offer to initiate, a social interaction with one or more other readers who share a similar reading position in the book. This can include, for example, providing an offer for the reader to chat with readers who have just finished the same chapter as the reader. It could further include allow the reader to ask a question to other readers of the book. It could further include sharing a blog with other users reading the book. Still further, it could include allowing the reader to answer a question asked by other readers.

As an example, after finishing the first chapter of the book, Wuthering Heights, the user may want to know “why Mr. Earnshaw decided to bring Heathcliff into his home”. This can be a good opportunity to chat with someone that just finished the chapter and can answer that question. So, the system can create an opportunity for the user to immediately communicate, potentially across the world, and ask that question. In some embodiments, geographically remote communicators can use tools such as automated language translation to facilitate the communication.

Some embodiments include the system including summary or interesting information relating to a concluded portion of a book, and also including targeting advertising. For example, after detecting the conclusion of the reading of a portion of a book, the system might show a useful or interesting fact relating to the concluded portion, in addition to associating it with a sponsored product, for instance. Example of this could be, “Did you know that 2,000 readers are currently reading the same chapter that you just finished . . . . This fact was brought to you by (Bookstore)”. Another example could be, “Author John Doe recalled his boyhood home in Missouri when describing the house on this page . . . . This note bought to you by (Coffee Brand) . . . why not grab a cup while you're reading!” Alternatively, the reader could be invited to read more about the fact that has been provided, or choose to ignore it. If the reader chooses to read more, then more advertisement targeting can occur. An example of this could be, after finishing the last chapter of Wuthering Heights, the system could show a fact including the most asked question from other users on the last chapter, such as, “The most asked question of Wuthering Heights: Where did Heathcliff go? Brought to you by (media company).”

Some embodiments include providing social recommendations. For example, upon a reader finishing a book, the system may mine one or more social networks of the reader, and information regarding people in the reader's social network, to provide recommendations.

In some embodiments, integrating the social experience will lead to even more appealing and richer advertising targeting opportunities. For example, it becomes possible to learn and determine exactly how the user responds to the emotions, such as a positive or negative response to a particular type of hu or, etc.

While the invention is described with reference to the above drawings, the drawings are intended to be illustrative, and the invention contemplates other embodiments within the spirit of the invention.

1. A method comprising:
using one or more computers, obtaining usage information regarding reading-related usage of an ebook by a reader;
using one or more computers, based at least in part on the usage information, determining or approximating a portion of the ebook being read by the reader; and
using one or more computers, based at least in part on the portion, targeting the reader with an advertisement to be presented at least in pa via the ebook.

2. The method of 1, wherein the targeting comprises emotional targeting.

3. The method of claim 1, comprising obtaining the usage information, wherein the usage information comprises navigational information.

4. The method of claim 1, comprising obtaining the usage information, wherein the usage information comprises information regarding a time or an approximate time of the reading-related usage.

5. The method of claim 1, comprising targeting the reader with the advertisement within a time period following a time or an approximate time of the reading-related usage.

6. The method of claim 1, wherein the usage information is used to determine or approximate a portion of the ebook being read.

7. The method of claim 1, wherein the usage information is used to determine or approximate a portion of the ebook having been completed within a period of time.

8. The method of claim 1, wherein the usage information is used to determine or approximate a portion of the ebook having been completed within a period of time, and wherein the targeting is based at least in part on the portion having been completed within the period of time.

9. The method of claim 1, comprising obtaining the usage information, wherein the usage information comprises page-flip or portion-flip information.

10. The method of claim 1, comprising obtaining the usage information, wherein the usage information comprising scrolling information.

11. The method of claim 1, comprising obtaining the usage information, wherein the usage information comprises zooming information.

12. The method of claim 1, comprising obtaining usage information, wherein the usage information comprises historical reading rate information associated with the reader.

13. The method of claim 1, comprising obtaining usage information, wherein the usage information comprises audio information.

14. The method of claim 1, comprising obtaining usage information, wherein the usage information comprises read-along information or read out-loud information.

15. A system comprising:
one or more server computers coupled to a network; and
one or more databases coupled to the one or more server computers;
wherein the one or more server computers are for:
obtaining usage information regarding reading-related usage of an ebook by a reader;
based at least in part on the usage information, determining or approximating a portion of the ebook being read by the reader; and
based at least in part on the portion, targeting the reader with an advertisement to be presented at least in part via the ebook.

16. The system of claim 15, wherein the usage information is collected at least in part utilizing the ebook.

17. The system of claim 15, wherein the usage information is collected at least in part remotely from the ebook.

18. The system of claim 15, wherein the advertisement is delivered offline via the ebook.

19. The system of claim 15, wherein the advertisement is delivered online using one or more server computers remote from the book.

20. A computer readable medium or media containing instructions for executing a method comprising:
using one or more computers, obtaining usage information regarding reading-related usage of an ebook by a reader;
wherein the usage information comprises page or portion flip, zooming, highlighting or scrolling information;
using one or more computers, based at least in part on the usage information, determining or approximating a portion of the book being read by the reader; and
using one or more computers, based at least in part on the portion, targeting the reader with an advertisement to be presented at least in part via the ebook;
wherein the targeting comprises emotional targeting based at least in part on emotional characteristics associated with the portion.
